(19) United States
(12) Patent Application Publication
(10) Pub. No.: US 2019/0251588 A1
(43) Pub. Date: Aug. 15, 2019

(54) Business promotion

(71) Applicant: Raphael Mourad, Toronto (CA)

(72) Inventor: Raphael Mourad, Toronto (CA)

(21) Appl. No.: 15/932,147

(22) Filed: Feb. 12, 2018

(51) Int. Cl. G06Q 30/02; G07F 17/32

(52) U.S. Cl. CPC G06Q 30/0212; G07F 17/329

(57) ABSTRACT

A method of providing prizes to lucky individuals among visitors to special events or attendees at business enterprises, entertainment locations or at shopping malls is disclosed. The disclosure would motivate the general public to attend these events, enterprises, entertainment or shopping malls more frequently hoping to win a prize and to feel like being in a safer and more secured environment. The method would also provide the business proprietors with improved foot traffic and more secure business premises.

### CROSS REFERENCE TO RELATED APPLICATIONS

This application claims priority to U.S. application Ser. No. 62/600,183, filed on Feb. 16 2017, which is hereby incorporated by reference for all purposes.

### BACKGROUND

It is well known that online business and transactions have been booming and are dominating conventional businesses. Nowadays, people prefer shopping for almost everything (clothing, furnishing, entertainment and more) by going online rather than by physical attendance at stores. This preference is mainly due to convenience, money and time savings considerations, but also due to self-confidence, health and security reasons. The purpose of this invention is to bring people back to gathering events and shopping malls while providing them with a better, more profitable and safer environment.

### PREFERRED EMBODIMENTS

Two preferred embodiments are disclosed: promotions to poker room players in casinos, and to shoppers in malls. However, it should be recognized that the present invention is applicable to any business which must attract customers to their physical locations.

Low-stakes poker players in casinos love promotions, which allow them, if luck is on their side, to take home a lot more money than they could expect to win through straight poker in using their own skill. Perhaps the most common promotion is a high-hand bonus. Typically, if you have four of a kind or a straight flush or royal flush, you win some cash. The amount is usually fixed, in the range of $100 to $1000, and paid to the highest hand winner during a session of typically one hour. The results of the action at other casino games might be used rather than poker hands. Obviously, these players will be much more attracted to go to casinos rather than play online, and stay much longer at the casinos, if they have the potential to win an additional larger monetary prize due to their luck rather than to their skill.

This disclosure provides these bonus winners the opportunity to compete against each other and potentially win a much higher prize. In addition to the fixed bonus payout provided at regular intervals to the player with the highest hand in a poker room, winners of N consecutive sessions are provided with the option to compete against each other with the winner of that competition winning an extra bonus prize which could be much larger than their previous prizes. The competition may done by use of a random generator device such as spinning a big wheel with R sections, with each section bearing a different prize value, or by randomly shake X regular dice, whereas the outcome of the N spins or N rolls defines the winner of the extra bonus prize and the prize won whereas the other N−1 fixed bonus winners win the fixed bonus only. This competition can be further extended by having a second competition (say done weekly) among R first competition winners to potentially win a bigger prize. Since these competitions may have a high stake and high prizes, the wheel or the dice shaker must be electrically/electronically automated spun or shaken to avoid outcome manipulation and to obtain random and fair results. Preferably the winners of the fixed bonuses and/or the contestants for the extra bonus prize will be required to sign in with at least their identities and preferably their e-mail and/or mailing addresses for both purposes of security and to allow the casino to communicate future promotions to them.

1. Shoppers would love to go to business enterprises, retail stores theaters or malls, if they are provided with monetary and safety incentives. These shoppers will be much more attracted to go to shopping malls, for instance, rather than purchase online, and stay much longer at the malls, if they have the potential to win valuable prizes based on their purchases in the mall and their personal luck. The mall management will provide, at periodic sessions, such as once an hour during the store hours, a prize drawing winner who will receive a refund of say 50% of the purchase price of one of the items that the winner has purchased during the said session. In addition to the refund payout, which may be provided say hourly to the winner at each session, winners of N consecutive sessions, are provided with the option to compete against each other with the winner of that competition being awarded an extra bonus prize which could exceed the hourly prizes, possibly by a substantial amount. The competition may be done by randomly spinning a big Roulette type wheel with R sections, each section bearing a prize value, or some other random choice device such as an automated dice shaker, with the outcome of N spins or N rolls defining the winner of the extra bonus prize and the prize won. In order to undertake the draw to qualify for the refund and the draw of the bonus prize, each participating shopper must sign in and establish their identity, which obviously will add a safety element to the undertaking.

While the method of the present invention has been described in connection with a casino and a retail store, it may obviously applied to other venues such as movie theaters, with the prizes awarded for repeated attendance over a period of time.

Having thus described my invention I claim:

1. The method of attracting patrons to a business venue, comprising: at first intervals of business hours of the venue awarding a first prize to a selected patron of the venue based on that patrons activities at the venue and at a second longer interval consisting of a number of said first intervals, providing a contest between the award winners at the previous first intervals for an additional prize, the contest winner being based in a random choice device.

2. The method of claim 1 wherein the business venue is a gaming casino and the patrons selected during the first intervals to be awarded prizes are chosen based on the results of their play at the casino during that interval.

3. The method of claim 1 wherein the business venue is a retail store or stores and the patrons selected during the first intervals to be awarded prizes are chosen based on their purchases from the store or stores during that interval.

4. The method of claim 3 wherein the prizes awarded to patrons selected during the first intervals to be awarded prizes are based on a percentage of the sales prices of their purchases from the store during that interval.

5. The method of claim 1 wherein the random chance device comprises a Roulette type wheel.

6. The method of claim 1′ wherein the business venue comprises a theater.

7. The method of claim 1 wherein the said first regular intervals comprise approximately one hour.

8. The method of claim 1 Wherein the additional prize is larger than said first prize.

9. The method of claim 1 wherein the first intervals are all of substantially the same length.

10. The method of claim 1, wherein patrons are required to sign in with their names and other identifying information to become eligible for prizes.

11. The method of claim 2 wherein the patrons selected during the first interval are playing poker during that interval and the patron with the highest poker hands during that interval are awarded the first prizes.
